(19) United States
(12) Patent Application Publication
(10) Pub. No.: US 2022/0184425 A1
(43) Pub. Date: Jun. 16, 2022

(54) PASSIVELY ENGAGED UNIDIRECTIONAL FRICTION LOAD CONTROL DEVICE

(71) Applicant: Jonnathan M. Busko, Bangor, ME (US)

(72) Inventor: Jonnathan M. Busko, Bangor, ME (US)

(21) Appl. No.: 17/544,343

(22) Filed: Dec. 7, 2021

Related U.S. Application Data
(60) Provisional application No. 63/124,969, filed on Dec. 14, 2020.

(51) Int. Cl. A62B 1/14

(52) U.S. Cl. CPC A62B 1/14

(57) ABSTRACT

A passively engaged unidirectional friction load control device having a rope-encasing shell with two points of rope redirection therein to generate friction that varies with the mass of the load during a lowering procedure and minimizes friction during an unloaded raising procedure.

### CROSS REFERENCE TO RELATED APPLICATIONS

This application claims the benefit of the provisional patent application, U.S. Ser. No. 63/124,969 (“PASSIVELY ENGAGED UNIDIRECTIONAL FRICTION LOAD CONTROL DEVICE”), filed Dec. 14, 2020, by Busko, Jonnathan M., and currently pending, which is hereby incorporated by reference.

### BACKGROUND OF THE INVENTION

The present invention relates to load control device which incorporates principles of passively engaged unidirectional friction points.

Friction has been used to control the lowering of loads since before recorded history. Application of friction on a rope, regardless of the composition of that rope, generates heat and reduces the amount of input force necessary to control of the movement of the load under external force (typically centripetal or gravitational forces). These devices generally work by bending the rope. The capstan equation (also known as Eytelwein's formula), which relates the hold-force to the load-force if a flexible line is wound around a cylinder, allows for the prediction of the amount of friction that will occur based on the cumulative angles of bending applied to the rope and the respective coefficient of static and sliding friction for a given combination of the materials in contact (e.g., the rope and the object the rope is bent around). The amount of friction in turn results in proportional reduction in the amount of input force necessary to control the movement of the load.

In the last century the quality and consistency of ropes of all types has been transformed through advances in manufacturing processes. This has led to widespread advances in applications of rope control techniques across industries and in particular the rescue, recreational, tree care, and materials movement (e.g., construction and inventory control) fields. Thus, advances in any one rope control field have application in all rope control fields.

In rescue operations, lowering loads (in this case, humans) from a height remains a core practice. When the victims can be accessed by a rescuer who can make physical contact with them, there are a number of load lowering techniques that are well established. Commonly used techniques include establishing an anchor point at or above the level of the victims and lowering directly from the anchor and establishing an anchor point on the ground and a redirection point above the victims and controlling the load from the ground anchor.

There is another class of human rescue loads that need to be lowered for whom a rescuer cannot be physically proximate to the victims. Examples of such situations would include victims trapped by fire in a burning building or skiers trapped on a stalled ski lift. In such cases, rope rescue techniques are dependent on the ability to establish either an anchor or a redirection point above the victims and control the lowering from a remote location. For individuals trapped in a fire, current practice is to establish an anchor above the victims (on the roof or a floor above them), lower a rescuer to them (or in some cases have the lowering device attached to the rescuer such that the rope does not move and the rescuer slides, or rappels down the rope to the victim), and lower the victim to a safe point. Although this technique is well established for rapidly performing single victim rescues, for multiple victim rescues it requires repeated set-ups of the same system and multiple rescuers to access the victims.

In the case of a stalled chair lift rescuers cannot typically establish an anchor station above the victims. Exceptions to this include cable and helicopter based rescues; these techniques are uncommon. Instead, the vast majority of ski lift evacuations are performed using ground based techniques. An evacuation rope is passed over the lift cable to create a redirection point. One end of the rope is attached to a victim securing evacuation device such as but not limited to a rescue seat, a rescue triangle, a victim harness, or a strop. The other end (the control end) travels over the lift cable and returns to the rescuer on the ground. Both the victim securing evacuation device and the rescuer start out at the same level on the ground. The rescuer must pull down on the control end of the rope to raise the victim securing evacuation device up to the level of the victim. Once the victim is attached to the system via the victim securing attachment device, the rescuer on the ground uses some friction device or technique to control the lowering of the victim to the ground and, critically, serves as his own anchor. Therefore, if tension on the rescuer created by gravity acting on the victim exceeds the force of gravity acting on the rescuer, the rescuer will be lifted into the air and/or lose control of the lowering of the victim. No matter how efficient or effective the friction device is, if it is attached to the rescuer and the tension applied by the load exceeds the mass of the rescuer, the rescuer will be lifted off the ground.

A myriad of devices and techniques exist to apply friction to the rope to control the lowering. These devices considered to be the most appropriate for rescue are almost all designed for active control by the rescuer. In other words, the rescuer must be physically proximate to device and actively control its function during the lowering including releasing a brake on the rope and controlling the speed of the rope as it passes through the device. Examples would include the Petzl I′D descender, the Petzl Maestro descender, the CMC-Harken Clutch, the CMC MPD, the Kong Indy, and many others. There are exceptions to these proximity and control requirements although not all of these devices are considered as frontline devices for rescue and none are specifically designed with the intention that they be used at a physical distance from the rescuer. Examples of such devices and techniques including the FIG. 8 descender and stitch plates (numerous manufacturers), various carabiner wraps such as the Münter Hitch, the Kong Oka, the Black Diamond ATC, the Mammut Smart, the DMM Pivot belay devices, and many others.

With the exception of the Petzl Maestro descender, the CMC-Harken Clutch, and the CMC MPD, these devices and techniques are designed to generate significant friction no matter which direction the rope is moving. For example, regardless if the rope is moving through a Black Diamond ATC while lowering a load or being pulled through the ATC in the opposite direction to raise a load, if an equal amount of tension is applied to a rope passing through it, it will generate equivalent amounts of friction. Therefore, these devices are designed to only to lower under load, not to raise.

The Petzl Maestro descender, the CMC-Harken Clutch, and the CMC MPD use a unidirectional pulley that allow the devices to generate friction by locking the pulley wheel when the rope moves in one direction (to control a lower) but to turn freely when the rope moves in the other direction (to perform a raise). However, these devices are not designed to travel with a load without active intervention by a controller.

For victims being lowered from a stalled ski lift (or in similar rescue, recreational, tree care, or industrial load management applications in which a lowering anchor point cannot conveniently be established above the load and when a secure anchor point cannot be conveniently established below the load and when a single rope is doubled over a redirection point above the load with one end attached to the load and the other (control) end is managed by a rescuer or worker from below the load), safety and control would be significantly increased if a friction generating device was attached to the load such that the control end of the rope passes through the device and adds friction to the system in such a way that much of the tension is applied to the high redirection point and only a small fraction of the original load force is experienced by the rescuer. Such a device would need to:

1. Be passively actuated (must not require a rescuer, worker, or victim to control the device).

2. Be capable of being passively disengaged when the load holding device (e.g., the victim securing evacuation device such as a rescue seat, a rescue triangle, a victim harness, or a strop in the case of a lift evacuation, or a loading strap in the case of tree care) is pulled up to the victim or load by the rescuer or worker on the ground, else there would be too much friction to pull the load holding device back up to the level of the load.

3. Allow for the rope to move through the device without sufficient braking action to completely stop movement of the load during the lower.

To date, the only technique that has been specifically utilized to attempt to generate friction at the load to reduce tension on the rescuer is the addition of a braking carabiner. The braking carabiner, when attached to the load, will create friction if the control end of the rope is offset from the axis of the load being lowered and the control end of the rope is bent around the carabiner. Although this technique is commonly used, the amount of friction that will be generated is highly variable, depends entirely on how much the control rope is bent around the carabiner, will not provide any friction if the rescuer is within a few degrees of the axis of the load being lowered, and cannot bend the rope more than 90 degrees which, for steel or aluminum carabiners, will result in only a 20% reduction in the force experienced by a rescuer based on the capstan equation. In fact, this technique starts by applying almost 0% reduction in force at the start of the lower and, as the rope is bent further, reduces it by no more than 20% which is only seen when the control rope is bent 90 degrees which only occurs when the victim has reached the ground.

Most efforts to date have focused on ways to modify the scenario. These include the use of helicopters to lower in rescuers and using trolleys to allow rescuers to ride on the lift cable and perform a lowering evacuation from above. Although feasible, these techniques are manpower and equipment intensive, are expensive, expose rescuers to increased risk, and slow down the speed of an evacuation significantly. Therefore, from a practicability perspective, these techniques can be considered failures.

In some ways this scenario could be considered similar to a lowering device attached to the top of a tripod. The Petzl Maestro descender, which uses a brake arm, is designed with a small hole in the brake arm to which a control cord can be attached. While this allows for remote disengagement of the “parking brake” action of the Maestro, this would not be practical for this application. First, the additional control cord is at risk of tangling with the rest of the rescue system when being raised and lowered which would result in the load becoming stuck with no way to free it. Second, if the cord were to part during an evacuation, the load would similarly be stuck.

Finally, there are devices called rope clamps or ascenders that are designed to move freely in one direction on the rope and engage the rope with friction in the opposite direction. These devices, however are designed to completely stop movement of the load, not to provide additional friction while allowing the load to move. Therefore, they would not be practical to use in this application.

As described herein, there are currently no devices designed to be integrated into a single rope lowering system that are attached to a load, are designed to be raised without creating friction, are designed to automatically actuate when the load is applied, and designed to reduce the tension experienced by a human below the load who is lowering the load.

It is therefore shown that there is a need for an improved integrated single rope lowering system that is attachable to a load.

It is therefore an object of the present invention to provide for an improved integrated single rope lowering system that is attachable to a load.

It is a further object of the present invention to provide for an improved integrated single rope lowering system that is attachable to a load and can be raised without creating friction.

It is yet a further object of the present invention to provide for an improved integrated single rope lowering system that is attachable to a load and can automatically actuate when the load is applied.

It is yet a further object of the present invention to provide for an improved integrated single rope lowering system that is attachable to a load and can reduce the tension experienced by a human below the load who is lowering the load.

Other objects of the present invention will be readily apparent from the description that follows.

### SUMMARY

The problem described above can be solved with the use of a descent control device that uses fixed friction points that are positioned such that when a load is applied, the device flips into an upright position and the rope is bent around the friction points, see FIGS. 4 and 6A, but when the device is unloaded, it falls into a downward position and the rope passes through the device without contacting the friction points, see FIGS. 5 and 6B. With this design, when the device is attached to the unloaded load holding device (e.g., the victim securing evacuation device such as a rescue seat, a rescue triangle, a victim harness, or a strop in the case of a lift evacuation), pulling on the control end of the rope raises the load holding device and the descent control device flips downward, completely disengaging friction from the rope and traveling upwards with the load holding device. Once the load holding device reaches the load (victims in the case of a rescue) and is loaded, the descent control device flips into the upright position, the friction points engage the rope, and the rope is bent between 200 and 270 degrees, resulting in a reduction in the tension seen by the rescuer by 40-50% at all times during the lower. The only other technique to replicate the action of the device of the present invention is the use of a carabiner, ring, or other rigid connector attached to the load to create an additional point of friction. As described above, this approach can at most reduce tension by 20%, does not provide consistent friction, and requires the rescuer to stand well away from the centerline of the lift cable to provide any friction. The device of the present invention provides consistent friction that reduces the load-generated tension experienced by the rescuer by 40-50% and can be used with the rescuer standing in any position.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims.

### DESCRIPTION OF THE DRAWINGS

FIG. 1A is a side plan view of the first side of the shell of the device of the present invention.

FIG. 1B is a side plan view of the second side of the shell of the device of the present invention.

FIG. 1C is a rear plan view of the spine of the shell of the device of the present invention.

FIG. 1D is a top plan view of the top of the shell of the device of the present invention.

FIG. 2A is a side plan view of the first side of the shell of the device of the present invention in which a removable pin is utilized as the second friction point.

FIG. 2B is a side plan view of the second side of the shell of the device of the present invention in which a removable pin is utilized as the second friction point.

FIG. 2C is a rear plan view of the spine of the shell of the device of the present invention in which a removable pin is utilized as the second friction point.

FIG. 2D is a top plan view of the top of the shell of the device of the present invention in which a removable pin is utilized as the second friction point.

FIG. 3 is a plan view of one manufacturing embodiment of the device of the present invention, wherein the device is stamped out of a monolithic piece of stainless steel, and the sides are capable of being bent perpendicular to the spine and the top portion of the spine is capable of being rolled into the bending edge.

FIG. 4 is a stylized plan side view of the device of the present invention showing the movement of the rope when the device is used to lower an object. (Note: the representations of the rope, the load holding device, and the person being rescued are not to scale.)

FIG. 5 is a stylized plan side view of the device of the present invention showing the movement of the rope when the device is used to raise an object. (Note: the representations of the rope and the load holding device are not to scale.)

FIG. 6A is a plan side view of the device of the present invention in use, with a load securing device to be lowered attached thereto at the attachment point. (Note: the representations of the rope, the load holding device, the rescuer, and the person being rescued are not to scale.)

FIG. 6B is a plan side view of the device of the present invention in use, with the device unloaded and ready to be raised. (Note: the representations of the rope, the load holding device, and the rescuer are not to scale.)

### DETAILED DESCRIPTION OF THE INVENTION

The descent control device 1 of the present invention embodies a solution to the above-stated problem, providing a device 1 having two friction points 172, 174 incorporated into a shell 100 configured to partially encase a portion of rope 10.

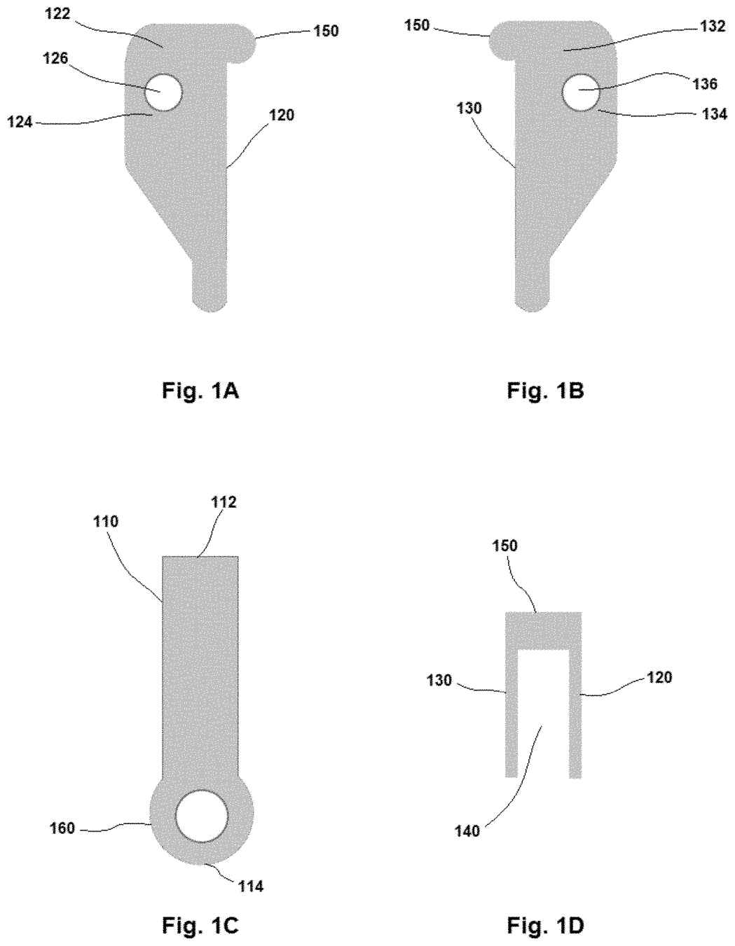

In the preferred embodiment, the shell 100 is comprised of a substantially planar spine 110, a substantially planar first side 120, and a substantially planar second side 130. See FIGS. 1A though 1C. The first side 120 of the shell 100 is attached to the left edge of the spine 110 in a substantially perpendicular orientation to the spine 110, and the second side 130 of the shell 100 is attached to the right edge of the spine 110 in a substantially perpendicular orientation to the spine 110, with the first and second sides 120,130 of the shell 100 being oriented substantially parallel to each other. This configuration results in the shell 100 having an open U-shaped channel 140 formed by its spine 110 and first and second sides 120,130 of the shell 100. See FIG. 1D. The channel 140 is appropriately sized to accommodate the thickness of a rope 10.

Across the top edge 112 of the spine 110, running substantially horizontally from the top portion 122 of the first side 120 of the shell 100 to the top portion 132 of the second side 130 of the shell 100, is a bending edge 150. The bending edge 150 should be substantially rounded and serves as a bending point (the first friction point 172) for the rope 10.

A second friction point 174 runs from a central portion 124 of the first side 120 of the shell 100 to a central portion 134 of the second side 130 of the shell 100, with the second friction point 174 oriented substantially perpendicular to the first side 120 of the shell 100 and substantially perpendicular to the second side 130 of the shell 100, and further being oriented substantially parallel to and spaced apart from the spine 110 of the shell 100, such that the gap 142 between the second friction point 174 and the spine 110 is sufficient to accommodate the thickness of the rope 10. The second friction point 174 should be substantially rounded and serves as a second bending point for the rope 10.

Located at the bottom edge 114 of the spine 110 is an attachment component 160, configured to provide a point of attachment of the load holding device 20 to the shell 100.

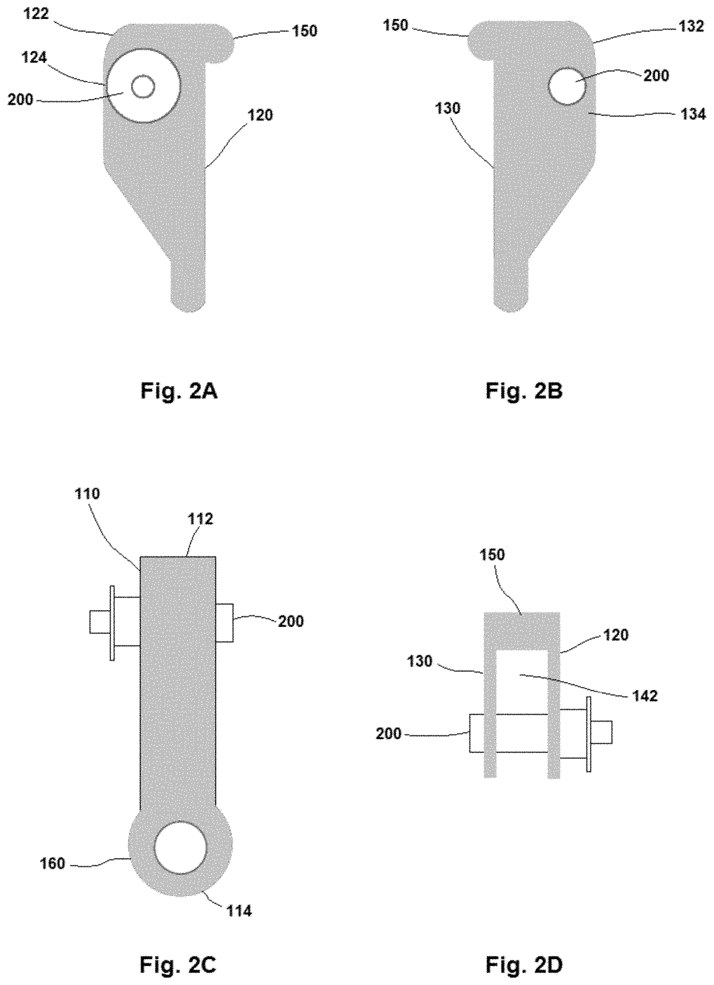

In one embodiment, the second friction point 174 is a removable pin 200. See FIGS. 2A though 2D. The first side 120 of the shell 100 comprises a first aperture 126 located in the central portion 122 of the first side 120 of the shell 100, and the second side 130 of the shell 100 comprises a second aperture 136 located in the central portion 134 of the second side 130 of the shell 100. The first aperture 126 is aligned with the second aperture 136. The removable pin 200 is removably inserted into the first aperture 126 and second aperture 136 and is securable at both ends. The pin 200, when removed from the shell 100, allows the rope 10 to be loaded into the channel 140 of the shell 100, and when the pin 200 is secured to the sides 120,130 of the shell 100 it holds the rope 10 within the channel 140 of the shell 100. The bending of the rope 10 around the removable pin 200 is the second bending point 174 for the rope 10, creating additional friction.

In other embodiments, the second friction point 174 may be a shackle, a carabiner, or another removable object that can be removed to allow the loading of a rope 10, and then replaced to secure the rope 10 in the shell 100. The same first and second apertures 126,136 are used to accommodate these alternative components.

In yet other embodiment, the second frictional point may be a fixed rounded pin. The first end of the fixed pin is located at the central portion 124 of the first side 120 of the shell 100, and the second end of the fixed pin is located at the central portion 134 of the second side 130 of the shell 100. In this embodiment, the free end of the rope 10 must be inserted into the channel 140 of the shell 100 and passed into and through the gap 142 between the fixed pin and the spine 110 of the shell 100.

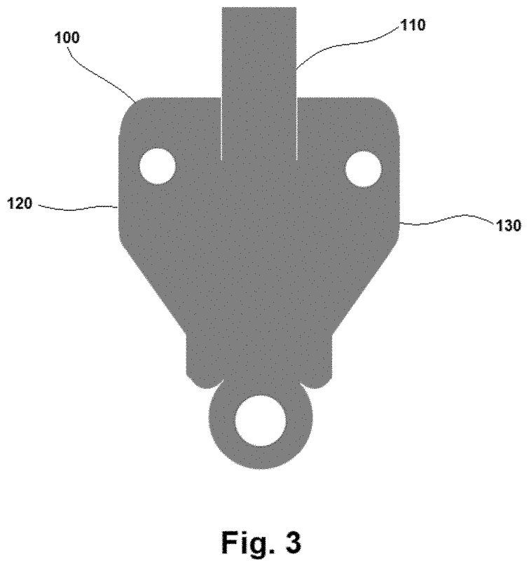

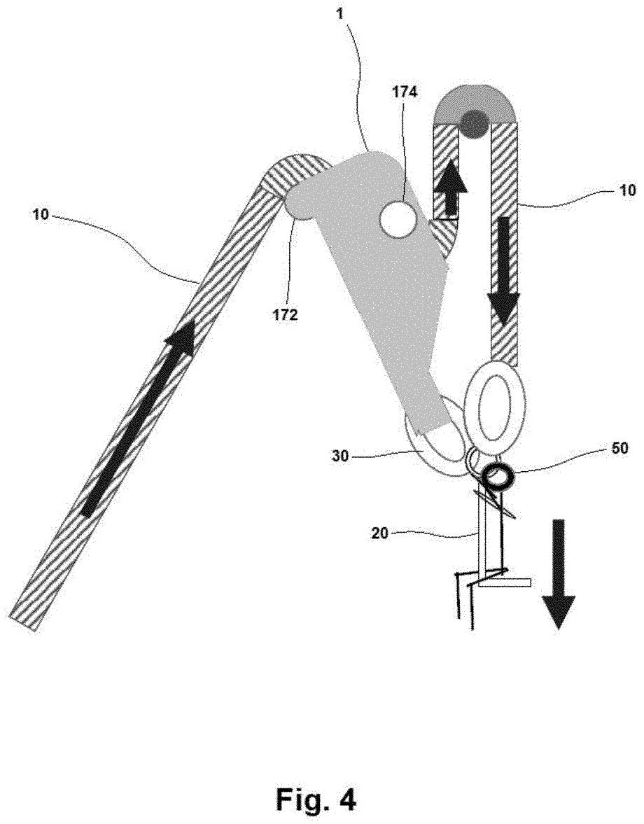

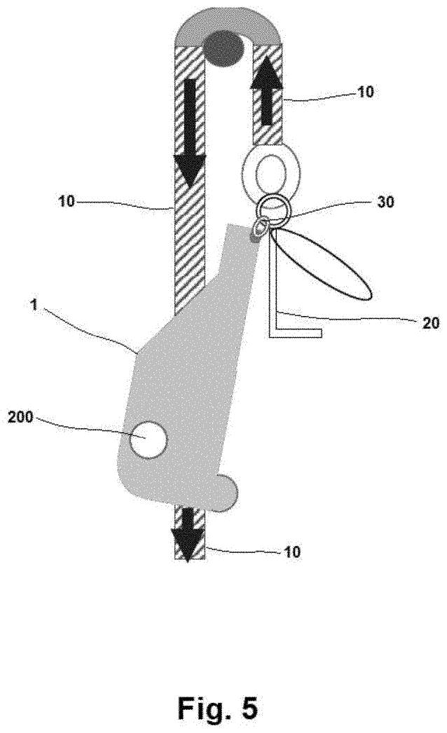

With regard to the shell 100, the shell 100 can be made of any high strength material including but not limited to steel, aluminum, or carbon fiber. In the preferred embodiment, stainless steel is chosen due to its high strength to weight ratio, its resistance to degradation from the elements and from repeated exposure to friction, and its ease of manufacturing. The shell 100 could be made any length, but in the preferred embodiment it is approximately 13 cm long, which gives it an adequate lever arm to rotate into its engaged and disengaged positions while minimizing its weight and the materials necessary to manufacture it. The channel 140 of the shell 100 could be made any width as long as the width is sufficient to accommodate a rope 10 of sufficient strength to safely lower the load. In the preferred embodiment the channel 140 has a width of approximately 15 mm to accommodate the most commonly used diameters of rescue and arborist ropes 10, which are between 11 mm and 12.5 mm in diameter. A 15 mm channel width allows either diameter rope 10 to be used safely without risk of binding while minimizing weight and materials. The first and second sides 120,130 of the shell 100 could be of any width. In the preferred embodiment each side has a maximum width of approximately 4 cm. This maximum width is located proximate to the top edge of the shell 100 and to the central portion of the shell 100. This width accommodates the location of the second friction point 174 while leaving a sufficient distance to the opening of the channel 140 for strength. The overall shape of the sides 120,130 of the shell 100 could be any shape. In the preferred embodiment, the sides 120,130 have a generally rectangular shape at their superior ends (closest to the top edge of the shell 100), with rounded corners for maximum strength where the friction of the rope 10 is greatest, and have a tapered shape on the inferior end (closest to the bottom edge of the shell 100) to minimize weight and material use, as well as to maximize mobility of the attachment device 30 with which the shell 100 interacts. In the preferred embodiment the spine 110 of the shell 100 is substantially rectangular. In the preferred embodiment the attachment component 160 is a ring, integrated into the bottom edge 114 of the spine 110 of the shell 100. In one embodiment the shell 100 may be formed from a single monolithic piece of material, with the sides bent to form the sides 120,130 of the shell 100 and the bending edge 150. See FIG. 3. In other embodiments, the spine 110, sides 120,130, bending edge 150, and attachment component 160 may be separate components that are then fixedly attached to each other. In yet other embodiments some subset of the components may be constructed from a monolithic piece of material, which others are separately manufactured and then fixedly attached.

With regard to the bending edge 150, the top edge 112 of the spine 110 of the shell 100 should be sufficiently rounded to minimize damage to the rope 10 and serve as a friction point 172. As long as this surface is sufficiently blunt as to not damage the rope 10 as it moves over said surface, it could have any shape and diameter. In the preferred embodiment, the bending edge 150 is rounded to a circular cylinder having a diameter of approximately 13 mm. The circular cylinder allows the smoothest bending of the rope 10, and a 13 mm diameter represents at least as great a diameter as that of the rope 10 that is bent around it, to minimize the risk of damage to the rope 10. The most commonly used diameters of rescue ropes 10 are 11 mm and 12.5 mm and therefore a 13 mm diameter safely accommodates both sizes of rope 10 while limiting weight and materials. In other embodiments, the bending edge 150 could have a substantially rectangular or hexagonal or octagonal cross section; provided that the edges are rounded, any such regular (or irregular) configuration may be used.

With regard to the second friction point 174, in the embodiment utilizing a removable pin 200, the removable pin 200 allows the rope 10 to be loaded, secures the rope 10 into the device 1, and bends the rope 10 to create friction. The removable pin 200 may be made of any material that is high strength and has an adequate coefficient of friction with the types of rope 10 to be used in the device 1, and of any size. In the preferred embodiment the removable pin 200 is a stainless steel pin having a circular cross-section with a diameter of 13 mm, with a push button release. Stainless steel has a high strength to weight ratio, is resistant to degradation from the elements and from repeated exposure to friction, and is simple to manufacture. Other materials are also contemplated. The circular cross-section allows the smoothest bending of the rope 10 and the 13 mm diameter is greater than the diameter of the most common sized ropes 10 used for rescue, to minimize the risk of damage to the rope 10. The most commonly used diameters of rescue ropes 10 are 11 mm and 12.5 mm and therefore a 13 mm diameter would safely accommodate both of them while limiting weight and materials. A push button release pin allows for easy removal and replacement while remaining secure. In a variant, the second friction point 174 may be a swinging gate, a carabiner, a shackle, or some other removable component, having substantially rounded edges.

The apertures 126,136 of the sides 120,130 of the shell 100 may be of any size that is sufficiently large to accommodate the removable second friction point object 174, and sufficiently small as to not compromise the strength of the sides 120,130 of the shell 100, and of any shape with at least 180 degrees being rounded. The locations of the apertures 126,136 could be anywhere along the sides 120,130 of the shell 100 as long as they are sufficiently distanced from the bending edge 150 to allow for the rope 10 to completely bend up to 180 degrees over the removable second friction point object 174 before bending again over the bending point. In the preferred embodiment, the apertures 126,136 are circular and have diameters of approximately 13 mm. This is to accommodate a 13 mm pushbutton removable pin 200, as described above. In other embodiments, differently sized and shaped apertures 126,136 may be used. The apertures 126,136 may be located any distance from the spine 110 of the shell 100; in the preferred embodiment the apertures 126,136 are located approximately 25 mm at their center points from the spine 110. This distance provides a clearance between the inside edge of the removable pin 200 and the spine 110 of approximately 18 mm, which is adequate clearance for the rope 10 to be free running between the pin 200 and the spine 110 of the shell 100 when the rope 10 is disengaged. In addition, in the preferred embodiment the apertures 126,136 are located with their center points approximately 20 mm from the bending edge 150. The distance of 20 mm allows the rope 10 to bend completely around the removable pin 200 and straighten before bending the opposite direction around the bending edge 150, which maximizes the bending angles and thus the friction and tension reduction. Similar positioning of the apertures 126,136 may be used in the embodiments comprising alternate variants to the removable pin 200.

With regard to the attachment component 160, any component allowing for the attachment of the device 1 to the load holding device 20 is contemplated. In the preferred embodiment, the attachment component 160 is a reinforced aperture having an inside diameter of approximately 16 mm through the lowest portion of the spine 110 of the shell 100. This allows for any number of different types of connectors 30 (e.g., carabiners, screw links, soft attachments, etc.) to be used to attach the descent control device 1 to the load holding device 20.

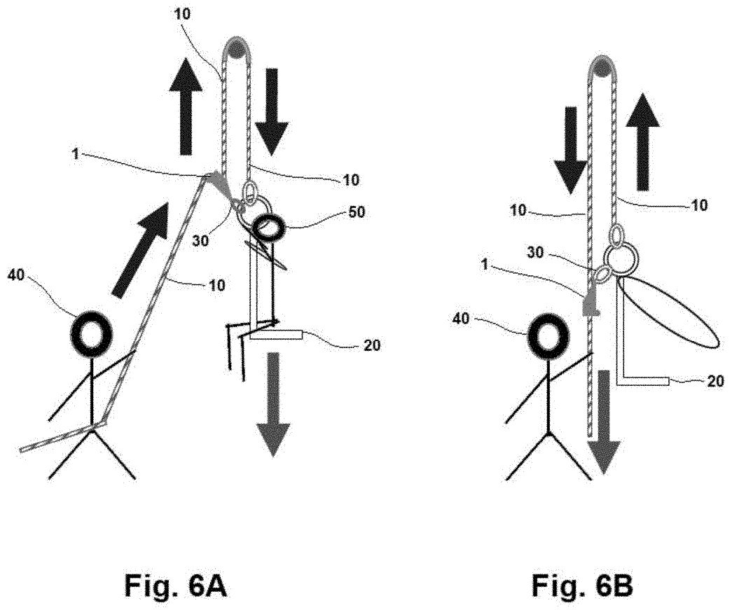

The device 1 may be used as depicted in FIGS. 6A and 6B. In one embodiment, the device 1 may be used to perform a rescue of a person 50 stranded on a ski lift chair. When performing a rescue using the device 1, a rescuer 40 throws a rope 10 over a portion of the ski lift chair near the person 50 needing rescuing, with the result that both ends of the rope 10 are in possession of the rescuer 40. The rescuer 40 then attaches a load holding device 20, for example, a rescue seat, to one end of the rope 10, and inserts the other end of the rope 10 through the device 1, with the lower portion of the device 1 oriented upwards, and then attaches the load holding device 20 to the attachment component 160 of the device 1. See FIG. 6B. The rescuer then hauls on the free end of the rope 10; the rope 10 passes freely through the device 1 and the load holding device 20 is raised to where the person 50 needing rescuing is located. See FIG. 6B. The person 50 climbs into the load holding device; the combined weight of the load holding device 20 and the person 50 causes the device 1 to flip over, such that the lower portion of the device 1 is now pointed downwards. See FIG. 6A. The rescuer 40 then plays out the rope, which passes through the two friction points 172, 174 of the device, and slowly lowers the person 50 in a controlled manner. See FIG. 6A. Other uses for the device 1 are also contemplated by the present invention.

While the preferred embodiments of the present invention have been described, modifications can be made and other embodiments may be devised without departing from the spirit of the invention.

1. A passively engaged unidirectional descent control device comprising
a shell, a first friction point, a second friction point, and an attachment component,
wherein the shell is comprised of a spine, a first side, and a second side, with the spine being substantially planar, the first side of the shell being substantially planar and attached to a left portion of the spine such that the first side of the shell is oriented substantially perpendicular to the spine, the second side of the shell being substantially planar and attached to a right portion of the spine such that the second side of the shell is oriented substantially perpendicular to the spine and substantially parallel to the first side of the shell, whereby the first side of the shell, the spine, and the second side of the shell form an open sided U-shaped channel,
the first friction point is located across a top edge of the spine, running substantially horizontally from the first side of the shell to the second side of the shell, thereby forming a bending edge,
the second friction point runs from a central portion of the first side of the shell to a central portion of the second side of the shell, with the second friction point oriented substantially perpendicular to the first side of the shell and substantially perpendicular to the second side of the shell, and further being oriented substantially parallel to and spaced apart from the spine of the shell, forming a gap between the second friction point and the spine, and
the attachment component is located at a bottom portion of the spine.

2. The device of claim 1 wherein the shell is manufactured from stainless steel.

3. The device of claim 1 wherein
the first side of the shell comprises an aperture formed therethrough at a central portion of the first side of the shell, and
the second side of the shell comprises an aperture formed therethrough at a central portion of the second side of the shell, with the aperture formed into the second side of the shell being aligned with the aperture formed into the first side of the shell,
whereby the second friction point is configured to be removably inserted into the apertures of the first and second sides of the shell and secured therein.

4. The device of claim 3 wherein the second friction point is one of the group of a removable pin, a shackle, a swinging gate, and a carabiner.

5. The device of claim 1 wherein
the second friction point is a fixed pin, with a first end of the fixed pin located at a central portion of the first side of the shell and secured thereto, and a second end of the fixed pin located at a central portion of the second side of the shell and secured thereto,
whereby the fixed pin is oriented substantially perpendicular to the first and second sides of the shell.

6. The device of claim 1 wherein
at least a portion of the first friction point is substantially rounded, and
at least a portion of the second friction point is substantially rounded.

7. The device of claim 1 wherein the shell is formed from a single monolithic piece of material, with the sides of the monolithic piece of material bent to form the sides of the shell and a middle portion of the monolithic piece of material rolled to form the bending edge.

8. The device of claim 1 wherein one or more of the spine, sides, bending edge, and attachment component of the shell are separate elements that are fixedly attached to each other.

9. The device of claim 1 wherein the shell has a length of between 10 cm and 15 cm, the channel of the shell has a width of between 12 mm and 18 mm, the first side of the shell has width of between 3 cm and 5 cm, the second side of the shell has width of between 3 cm and 5 cm, the spine of the shell is substantially rectangular, and the attachment component is a ring integrated into a bottom edge of the spine of the shell.

10. The device of claim 1 wherein the shell has a length of 13 cm, the channel of the shell has a width of 15 mm, the first side of the shell has width of 4 cm, the second side of the shell has width of 4 cm, the spine of the shell is substantially rectangular, and the attachment component is a ring integrated into a bottom edge of the spine of the shell.

11. The device of claim 1 wherein the bending edge is a substantially rounded circular cylinder having a diameter of between 10 and 15 mm.

12. The device of claim 1 wherein the bending edge is a substantially rounded circular cylinder having a diameter of 13 mm.

13. The device of claim 1 wherein the attachment component is a reinforced aperture having an inside diameter of between 14 mm and 18 mm.

14. The device of claim 1 wherein the attachment component is a reinforced aperture having an inside diameter of 16 mm.

15. The device of claim 3 wherein
the second friction point is a removable pin, said removable pin being made of stainless steel and having a substantially circular cross-section, a diameter of between 10 mm and 15 mm, and a push button release,
whereby the removable pin is configured to be removably inserted into the apertures of the first and second sides of the shell and secured therein.

16. The device of claim 15 wherein the removable pin has a diameter of 13 mm.

17. The device of claim 3 wherein the apertures formed into the sides of the shell are substantially circular.

18. The device of claim 3 wherein the apertures formed into the sides of the shell are located between 22 mm and 28 mm from their respective center points to the spine.

19. The device of claim 3 wherein the apertures formed into the sides of the shell are located between 18 mm and 22 mm from their respective center points to the bending edge.

20. The device of claim 3 wherein the apertures formed into the sides of the shell are located 25 mm from their respective center points to the spine, and the apertures formed into the sides of the shell are located 20 mm from their respective center points to the bending edge.
